(19) United States
(12) Patent Application Publication
(10) Pub. No.: US 2006/0239612 A1
(43) Pub. Date: Oct. 26, 2006

(54) Flip-chip devices formed on photonic integrated circuit chips

(76) Inventors: Peter De Dobbelaere, San Diego, CA (US); Steffen Gloeckner, San Diego, CA (US); Roger Merel, Naperville, IL (US); Roger Koumans, Irvine, CA (US); Lawrence C. Gunn III, Altadena, CA (US); Thierry J. Pinguet, Cardiff-By-The-Sea, CA (US); Maxime Jean Rattier, Paris (FR)

Correspondence Address: KNOBBE MARTENS OLSON & BEAR LLP, 2040 MAIN STREET, FOURTEENTH FLOOR, IRVINE, CA, 92614, US

(21) Appl. No.: 11/195,357

(22) Filed: Aug. 2, 2005

Related U.S. Application Data
(63) Continuation-in-part of application No. 10/601,147, filed on Jun. 19, 2003.
(60) Provisional application No. 60/389,961, filed on Jun. 19, 2002.
(60) Provisional application No. 60/598,500, filed on Aug. 2, 2004.

(51) Int. Cl. G02B 6/34; G02B 6/12; G02B 6/26; G02B 6/42

(52) U.S. Cl. 385/37; 385/14; 385/15; 385/31; 385/88; 385/89

(57) ABSTRACT

Various embodiments include optically aligning and connecting optical devices to optical grating couplers using a variety of bonding techniques, as a means of transferring optical signals to and from optoelectronic integrated circuits.

### CROSS-REFERENCE TO RELATED APPLICATIONS

This application is a continuation-in-part of U.S. patent application Ser. No. 10/601,147 (Attorney Docket LUX-P004) filed Jun. 19, 2003 entitled “An Array of Active Optical Components Aligned to an Array of Grating Couplers,” which claims priority from U.S. Provisional application No. 60/389,961, filed Jun. 19, 2002, entitled “Active Optical Components Aligned to a Grating Coupler Array,” both of which are incorporated herein by reference in their entirety, and this application also claims priority to U.S. Provisional Application No. 60/598,500 filed Aug. 2, 2004 and entitled “Specification for Light Source Die or Module,” which is also incorporated herein by reference in its entirety.

### FIELD OF THE INVENTION

The present invention relates to an apparatus and method for facilitating the connection of integrated optical circuits to external optical components and devices.

### BACKGROUND

Grating couplers are a promising technology for coupling light between integrated optical elements and external components or devices. Grating couplers have advantages for use as optical input and output ports to optical or optoelectronic processing elements. Grating couplers are typically formed from lithographic techniques that create extremely precise positioning of grating couplers to other devices formed on the same substrate. It is not uncommon for current photolithography equipment to place elements with respect to one another with alignment precision on the order of 1-10 nm. For many optical devices, this type of precision far exceeds the tolerance requirements for accurate optical alignment. It is desirable to leverage this accuracy to enable cost-effective, parallel alignment of optical devices to the precisely located grating couplers.

### SUMMARY

The system, method, and devices of the invention each have several aspects, no single one of which is solely responsible for its desirable attributes. Without limiting the scope of this invention, its more prominent features will now be discussed briefly. After considering this discussion, and particularly after reading the section entitled “Detailed Description of Certain Embodiments” one will understand how the features of this invention provide advantages over other display devices.

One embodiment of the invention comprises an optical apparatus comprising at least one optical device, a photonic integrated circuit chip, and a substantially flux-free bond. The at least one optical device flip-chip is bonded to the photonic integrated circuit chip. The substantially flux-free bond provides electrical connection to the optical device and the photonic integrated circuit chip.

Another embodiment of the invention comprises an optical apparatus comprising at least one optical device, a photonic integrated circuit chip, and substantially optically transmissive filler material. The at least one optical device is flip-chip bonded to the photonic integrated circuit. The photonic integrated circuit chip comprises a least one optical coupler configured to couple light between the at least one optical device and the photonic integrated circuit chip. The substantially optically transmissive filler material is disposed in an optical path between the at least one optical device and the optical coupler.

Another embodiment of the invention comprises an optical apparatus comprising at least one surface emitting laser and a photonic IC chip. The at least one surface emitting laser comprises gain medium disposed in an optical resonant cavity having an optical axis. The surface emitting laser further comprises an output coupling element such that light exits the resonant cavity at an oblique angle with respect to the optical axis. The photonic IC chip comprises an optical coupler. The at least one edge emitting laser is flip-chip bonded to the photonic IC chip so as to form an optical path from the output coupling element of the surface emitting laser to the optical coupler of the photonic IC chip.

Another embodiment of the invention comprises an optical apparatus comprising at least one edge emitting laser, a photonic IC chip, and a beam deflector. The at least one edge emitting laser comprises gain medium disposed between first and second ends of an optical resonant cavity. Light in the resonant cavity can exit through the second end. The photonic IC chip comprises an optical coupler. The at least one edge emitting laser is bonded to the photonic IC chip. The beam deflector is disposed so as to direct light exiting through the second reflector of the edge emitting laser to the optical coupler.

### BRIEF DESCRIPTION OF THE DRAWINGS

FIG. 1 is a top view of a SOI substrate upon which is fabricated an array of grating couplers and metal pads.

FIG. 2 is a view of an array of optical devices, such as a photodetectors or VCSELs.

FIG. 3 is the cross sectional view of an optical device that has been flip-chipped over the grating coupler.

FIG. 4 is a perspective view of a laser diode array flip-chip bonded to an integrated optical circuit chip.

FIG. 5 is the cross sectional view of the laser diode array of FIG. 4 comprising a plurality of surface emitting lasers disposed on the integrated optical circuit chip.

FIG. 6 is a enlarged cross sectional view one of the surface emitting lasers on the integrated optical circuit chip showing laser beam propagating along an optical path therebetween.

FIG. 7 is a perspective view of a plurality of surface emitting laser diodes flip-chip bonded to a photonic integrated circuit (IC) chip.

FIG. 8 is perspective view of a laser module comprising a laser diode array comprising edge emitting lasers, microlenses, and a deflecting mirror.

FIG. 9 is the cross sectional view showing the laser module of FIG. 8 bonded to a photonic integrated circuit chip.

FIG. 10 is the cross sectional view of an edge emitting laser diode flip-chip bonded to a photonic integrated circuit chip.

FIG. 11 is the cross sectional view of an amplifier device bonded to a photonic integrated circuit chip to form an external cavity laser.

FIG. 12 is the cross sectional view of an optical amplifier bonded to a photonic integrated circuit chip to provide amplification.

### DETAILED DESCRIPTION OF THE PREFERRED EMBODIMENT

For the purposes of this invention, an array of elements will refer to two or more similar optical devices that are spaced with known positions with respect to one another in a plane and held rigidly in place with a substrate or other mechanical construction. An array containing multiple devices need not be evenly spaced in any dimension, although the relative positions are best well known and controlled in a high-volume assembly environment. However, various preferred embodiments include an array of evenly spaced devices.

Many optical devices that would be advantageously coupled to grating couplers are also formed from lithographic techniques. Examples include surface emitting lasers (e.g., VCSELs), Fabry-Perot lasers, diffractive elements, fiber V-groove substrates, and photodetectors. Furthermore, during the construction of optical devices, including grating couplers, other features, such as bond pads and fiducials can be formed with high relative precision to the optical element. Examples are the bond pads on a photodetector or laser die. Similar features can be placed on a substrate containing grating couplers.

It is desirable to use these fiducials and bond pads to facilitate flip-chip assembly of optical devices over optoelectronic circuits containing grating couplers. The flip-chipping process can use a solder or gold balls in what is commonly referred to as gold stud bumping. This approach has the advantage of also providing electrical and thermal contact between the substrate containing the grating couplers, and the optical device which is affixed on top. When electrical contract is not needed, these approaches are still valid, however additional flexibility, such as attachment via epoxy or other mechanical bonding technique is also acceptable.

It is also possible to grow, deposit or form optical structures over a substrate in what is referred to as an integrated optical circuit chip or photonic integrated circuit chip. These optical structures may be connected by waveguides and may themselves comprise waveguide structures. This integrated optical circuit may also contain a grating coupler or grating coupler array. The waveguides and structure may be formed via techniques involving chemical vapor deposition, physical vapor deposition, epitaxial deposition, sputtering, etching, photolithography, spin coating, screen printing, injection molding, stamping, or other physical processing techniques. A number of these techniques, such as CVD or other epitaxial growth can be self-aligned to the grating couplers.

Photolithographic techniques allow the processing and placement of optical devices over grating couplers with high precision using accurate alignment marks and specialized photolithographic equipment capable of the appropriate accuracy. Accordingly, in various preferred embodiments, the optical devices are also fabricated with photolithographic techniques of adequate precision to allow simultaneous optical alignment of all elements of the array with the array of grating couplers. An example would be an array of photodetectors fabricated on a substrate formed from a III-IV compound. These photodetectors are lithographically defined, and have bonding pads that are also lithographically defined and aligned with respect to the photodetector. The lithographic process easily lends itself to the construction of an array of these devices that is matched in dimension to the grating coupler array, and thus when these two arrays are flip chipped together, it is possible to ensure simultaneous alignment of all of the devices and structures.

During the flip-chipping process, fiducials and a number of active and passive alignment techniques can be used to align only a small number of the devices and/or structures, logically the first and last elements of a linear array, and ensure that all other devices and structures are aligned as well. It does not have to the first and fast elements, but in general the farther apart in the array that the small number of chosen devices and/or structures are, the better the alignment will be. In certain applications it may suffice that a single element, or two elements in the center of an array are aligned.

Examples of benefits derived from flip-chipping an array of optical elements such as VCSELs or photodetectors over a substrate are when the substrate contains both the optical circuit that connects to the optical element, and the electrical circuit that connects to the optical element. An example of an implementation would be a system to generate an electrical signal from optical signals in an array of waveguides in a substrate. A grating coupler array can direct the optical signals to a photodetector array that is flip-chipped over the grating coupler array. The flip-chipping process can simultaneously allow electrical connections to transimpedance amplifiers or other circuitry in the substrate that are used to process the signal from the photodetectors. Various embodiments of the present invention have many advantageous implementations involving all types of lasers, optical amplifiers and photodetectors, although a number of other devices could be used in a similar manner.

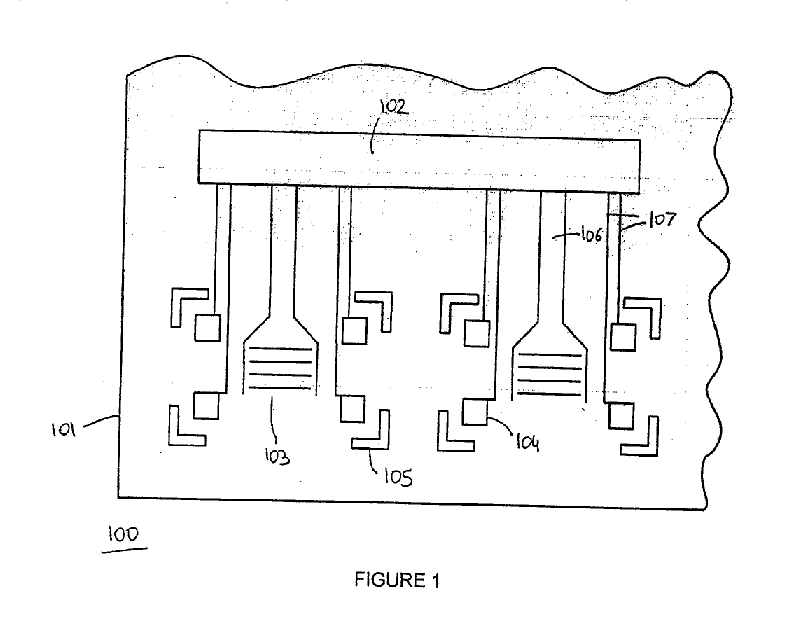

For example, FIG. 1 shows grating couplers 103 arranged in a linear array 100 disposed on a substrate 101 that also contains an optoelectronic device 102. This embodiment demonstrates a linear array of grating couplers, although an array of any shape and orientation may be used as well. In this embodiment there are metal pads 104 that serve the function of providing mechanical attachment and alignment as well as electrical connection via leads 107 to the optoelectronic device 102. Optical connection between the optoelectronic device 102 and the grating couplers 103 is achieved with an optical waveguide 106.

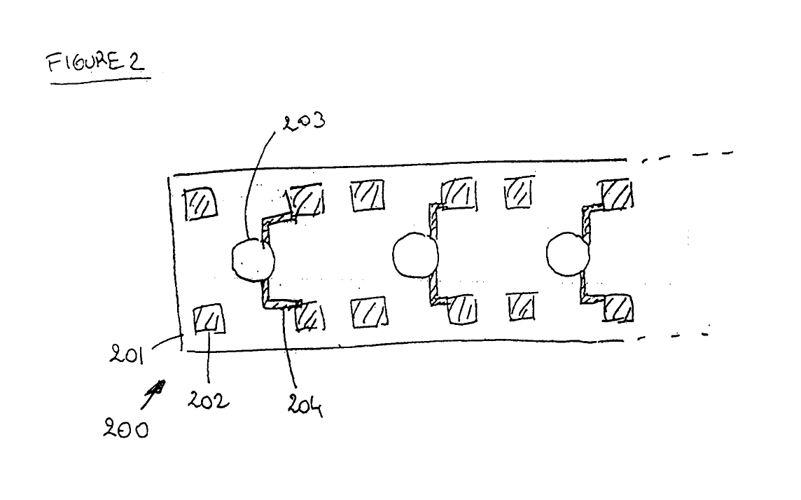

In addition, fiducials 105 are placed on the substrate to facilitate alignment of the optical devices to the grating coupler array. In this embodiment, fiducials 105 are placed that facilitate the flip-chip attachment of an array of optical elements 200 which are formed on a second substrate 201 as shown in FIG. 2.

FIG. 2 shows the optical elements 203, in this case representative of photodetectors or VCSELs, aligned in the corresponding linear array 200. Metal pads 202 are contained on the second substrate 201, and some are shown that will provide only mechanical attachment, while some also serve as the electrical connection to the optical elements 203 via electrical leads 204.

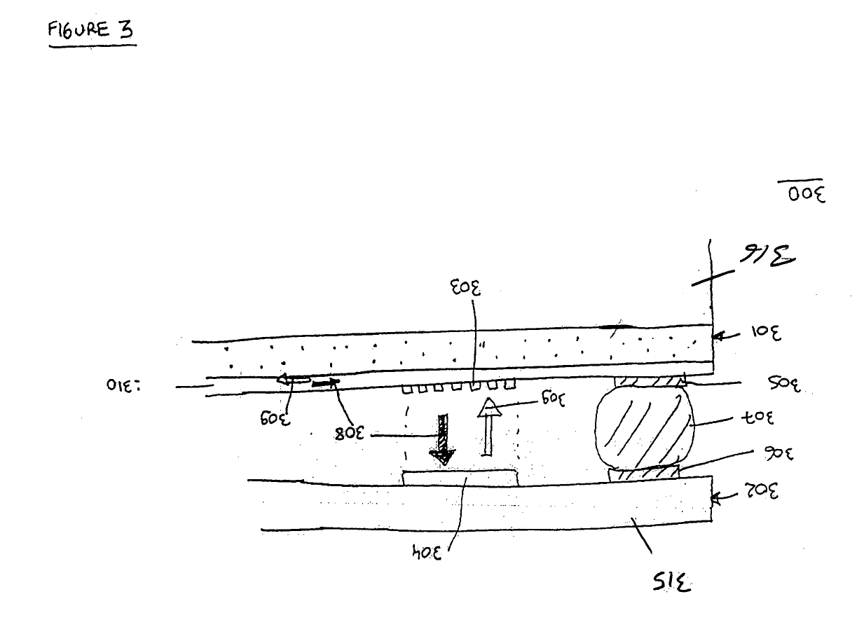

FIG. 3 shows a cross-section of the final assembly of the flip-chipped structure 300 where the substrate 315 containing optical devices 304 in an optical array 302, is electrically and mechanically attached to the substrate 316 containing the array of grating couplers 301 via a gold or solder ball 307. The ball directly connects a metal pad 306 on the optical device substrate 302 to a metal pad 305 on the grating coupler array substrate 301. Optical connection between the substrates is achieved by the grating coupler 303 and an input optical path 309 and/or an output optical path 308. Note that the paths comprise the waveguide 310 which is also shown in cross-section here.

In many cases, electronic circuits have an edge seal comprising, e.g., metal, that seals the electronic circuits and prevents contamination via diffusion of contaminants into nearby photonics and electronics components. In cases where optical devices containing such electronics are butt coupled to photonics chips, this seal is opened to allow light to couple in or out. Contaminants as well, however, can pass through causing severe reliability problems. One advantage of flip-chip mounting and using grating couplers for integration of external optical devices with photonic chips is that the edge seal ring need not be broken. The flow of contaminants is thereby reduced and reliability improved. Additionally, enhanced mode coupling between the optical device and the grating coupler can be provided in various embodiments.

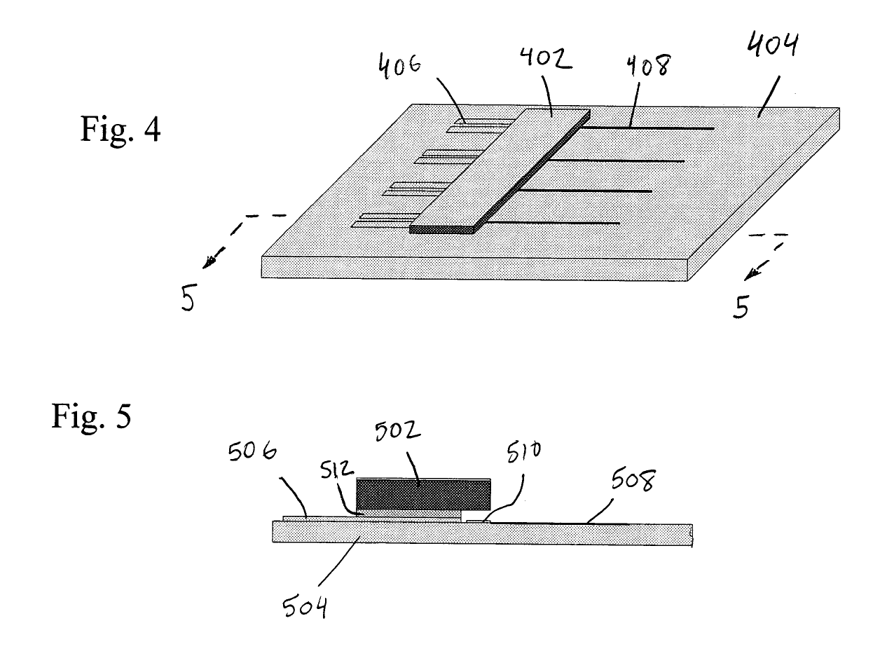

A perspective view of a laser diode array 402 bonded to a photonic integrated circuit chip 404 is shown in FIG. 4. Metal contacts 406 and optical waveguides 408 are shown on the photonic integrated circuit chip 404. The laser diode array 402 comprises a die that includes a plurality of laser diodes (not shown). These laser diodes may output light having the same or different wavelengths. The laser diode array 402 may be passively aligned. For example, instead of activating the laser diodes and monitoring the position of laser beam outputs from one or more laser diodes (referred to as active alignment), the die may be appropriately positioned with the laser diodes off. Proper positioning may be achieved, for example, by aligning or otherwise monitoring the physical location of features on the laser die 402 and/or photonic integrated circuit chip 404. Fiducials may be used in many cases. Moreover, automated visual alignment systems may be used. Other methods of alignment and/or positioning are also possible.

The laser diode array 402 comprises a plurality of surface emitting lasers such as shown in FIG. 5. FIG. 5 is a cross section through the laser diode array 402 along the line 5-5. FIG. 5 shows the laser die 502 disposed over the photonic integrated circuit chip 504, which includes a metal contact or pad 506 and an optical waveguide 508. The photonic integrated circuit chip 504 also comprises an optical coupler 510 such as a grating coupler for receiving and coupling light from the surface emitting laser into the optical waveguide 508.

The laser die may comprise a variety of materials including non-silicon based materials such as III-V semiconductor materials. For example, the laser diode may comprise GaAs, InP or alloys thereof. Other materials may be employed as well. In various embodiments, the photonic integrated circuit chip 504 comprises silicon based material such as silicon, silicon dioxide, or silicon nitride. The photonic integrated circuit chip 504 may include a silicon-on-silicon on oxide (SOI) substrate. Silicon and non-silicon based materials may be formed thereon or therein. Examples of structures that can be included in photonic integrated circuit chips 504 are described in U.S. Pat. No. 6,834,152 entitled “Strip Loaded Waveguide with Low-Index Transition Layer” and U.S. Pat. No. 6,839,488 entitled “Tunable Resonant Cavity Based on Field Effect in Semiconductors”, both of which are incorporated herein by reference in their entirety.

The laser die 502 is bonded to the photonic integrated circuit chip 504 using AuSn solder 512 between the metal contact or pad 506 and the laser die as shown in FIG. 5. The AuSn solder bond 512 can provide electrical as well as mechanical connection between the laser die 502 and the photonic integrate circuit chip 504. The AuSn solder bond 512 is a eutectic solder bond comprising about 80% gold (Au) and 20% tin (Sn). The melting point is lowest at the eutectic. Advantageously, AuSn solder is flux-free and thus reduces contamination of sensitive flip-chip mounted photonic elements. Other types of flux-free solder bonds (e.g. a gold bond) may be employed. Solder bonds that employ flux may also be used in some embodiments.

The AuSn solder can be applied, for example, by electroplating, evaporation, or using other deposition techniques. The solder can be patterned, for example, using photolithography. Accordingly, the size and position of the solder bond 512 can be precisely controlled. The laser die 502 and photonic integrated circuit chip 504 can be heated to form the bond. Other methods may also be employed.

In certain preferred embodiments, the AuSn solder bond 512 may be about 3 to 5 micrometers thick. Values outside this range are also possible. Advantageously, the reduced thickness results in a short distance between the laser die 502 and the optical coupler on the photonic integrated circuit chip 504. Reduced optical path length increases coupling efficiency. Additionally, thermal resistance between the laser die 502 and the photonic integrated circuit chip 504 is decreased causing higher conduction of heat through the solder bond 512 to the photonic integrated circuit chip 504, which acts as a heatsink.

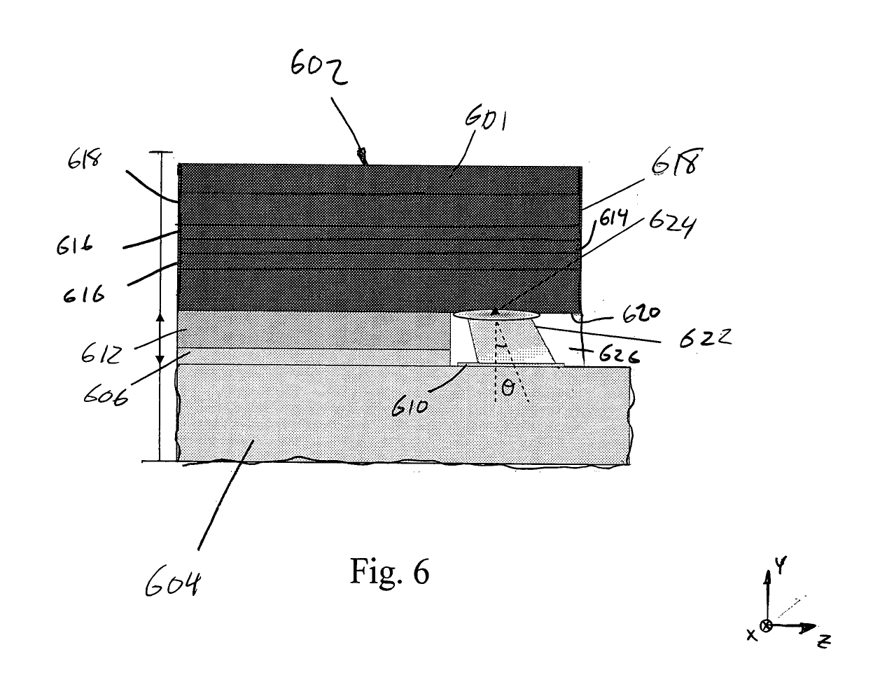

FIG. 6 shows a close up of a laser die 602 on a portion of the photonic integrated circuit chip 604. The laser die 602 is bonded to a contact 606 with a solder bond 612. In certain embodiments, the laser die 602 comprises a surface emitting laser comprising a plurality of layers of material that form a core region 614 surrounded by cladding 616. This core region 614 may comprise semiconductor material that introduces gain.

The plurality of layers may be grown on a substrate 601 to form the laser die 602. The laser die may be flip-chip bonded such that the plurality of layers (not the substrate 601) are closer to the solder bond 612. One of the layers, the uppermost during the growth process (and farthest from the substrate 612), may contact the solder.

In certain embodiments, reflectors 618 are disposed at opposite ends to form an optical cavity. These reflectors 618 may comprise, for example, etched or cleaved surfaces or dielectric coatings. This optical cavity has an optical axis. In FIG. 6, the layers of material are parallel to an X-Z plane and stacked along the Y direction; for reference, see XYZ axes in lower right of FIG. 6. The reflectors 618 are oriented perpendicular to the Z axis (e.g., parallel to the X-Y plane). The optical axis is parallel to the Z direction.

Other types of surface emitting lasers having horizontal cavities may also be used. For example, the reflectors 618 may comprise Bragg reflectors. Alternatively, such reflectors 618 may be excluded in a distributed feedback laser wherein a grating extends along the core region 614. Other types of surface emitting lasers such as Vertical Cavity Surface Emitting Lasers (VCSELS) may also be employed. Still other configurations and designs are possible.

Light propagates within the core region 614 along the Z direction. (In comparison, the light propagates in Y direction in Vertical Cavity Surface Emitting lasers, i.e., VCSELs.) In the surface emitting laser shown, the light is extracted from the core region 614 at an angle and propagates through one of the cladding regions 616, through a portion of the layers. In FIG. 6, the light is shown exiting a bottom surface 620 of the laser die 602. The light may be extracted from the core region 614 using a diffractive grating or mirror etched within the laser structure 602 as is well known.

FIG. 6 shows a laser light beam 622 output through an output port of the laser die 602. The laser light beam 622 is directed to the optical coupler 610 in the photonic integrated circuit chip. In various preferred embodiments, the light beam 622 is substantially matched to the optical mode supported by the optical coupler 610. A lens 624 is also shown. This lens 624 may mode couple the laser 602 with the optical coupler 610 in the photonic chip 604. This optical coupler 610 may comprise a waveguide grating coupler formed in the photonic chip 604. In other embodiments, coupling elements other than the lens 624 and grating 610 may be used. In various preferred embodiments, the laser beam 622 has a spot size of about 3 to 10 micrometers in diameter as measured at the exit facet of the laser. In various preferred embodiments, the light beam 622 is output at an angle, e.g., θ, in FIG. 6. This angle may be for example about 12°±0.5°. Other angles including smaller angles can be used as well.

As shown in FIG. 6, a substantially optically transmissive filler material 626 is disposed between the laser die 602 and the optical coupler 610. This substantially optically transmissive filler material 626 may comprise organic material. In certain preferred embodiments, the optically transmissive filler material 626 comprises epoxy or silicone, although other materials may be used. The substantially optically transmissive material 626 may fill the region between output surface 620 and the lens 624 to the optical coupler 610.

Advantageously, the filler material 626 may protect the sensitive surfaces of the optical elements (e.g., the lens 624, the output surface 620, and the optical coupler 610). The underfill 626 may also add mechanical strength to the flip-chip bond. The substantially optically transmissive filler material 626 may also improve optical performance. The filler material 626, having an index higher than that of air (1.0), may yield reduced beam divergence. Additionally, losses due to Fresnel reflection at interfaces may also be reduced.

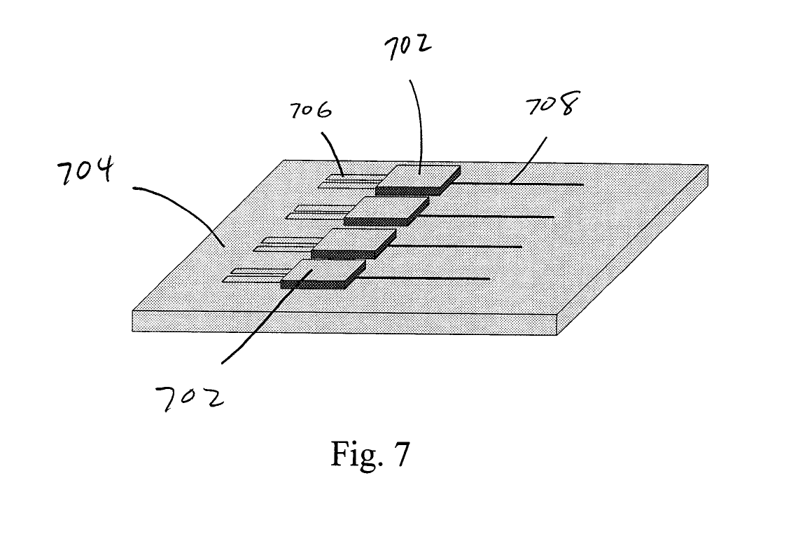

FIG. 7 shows a plurality of separate laser die 702 each comprising an individual laser bonded to a photonic integrated circuit chip 704. This photonic integrated circuit chip 704 also includes contact metallization 706 and waveguides or waveguide structures 708. FIG. 7 illustrates that different configurations are possible. For example, instead of a laser die 402 comprising an array of laser diodes formed thereon, a plurality of separate laser die 702 may be attached to the photonic integrated circuit chip 704. The separate laser die 702 may have different or same wavelengths. In certain embodiments, the separate laser die 702 operate at different wavelength corresponding to different channels.

More generally, a wide variety of optical devices can be bonded to the photonic integrated circuit chip 704. These devices may be light sources such as lasers or other types of light sources. Other devices are also possible. Some examples include optical sensors or detectors, modulators, etc.

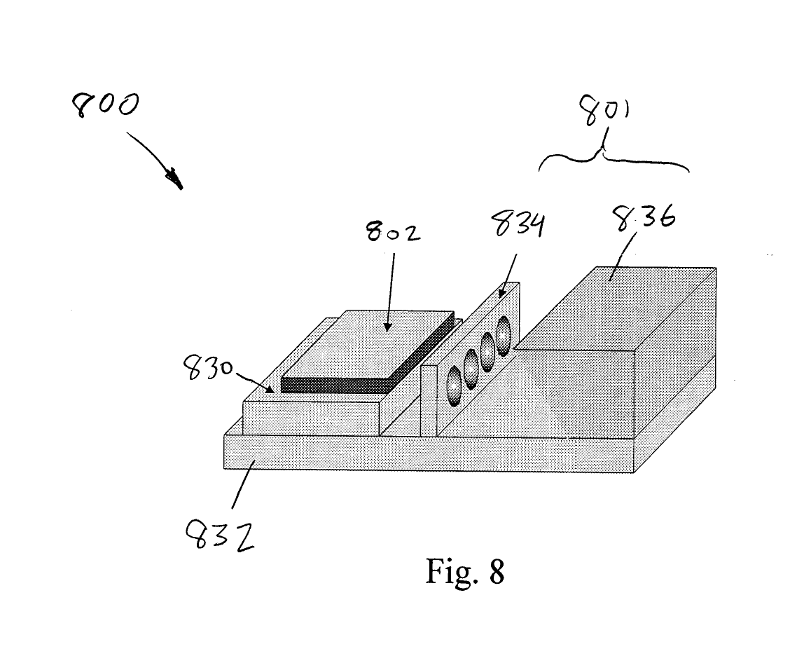

As shown in FIG. 8, a laser die 802 can alternatively be included in a laser module 800 together with auxiliary optics 801. FIG. 8 shows the laser die 802 bonded (e.g., flip-chip bonded) to a terrace 830 on a substrate 832. This substrate 832 may comprise a silicon-based material and may be a silicon substrate or a silicon-on-insulator (SOI) substrate in some embodiments. The substrate 832 may be antireflection (AR) coated, for example, on opposite sides of the substrate. The terrace 830 may comprise a silicon terrace on the substrate 832. The laser die 802 may be bonded to contacts or contact pads (not shown) on the terrace 830 using, for example, solder as discussed above.

The laser die 802 comprises a plurality of edge emitting lasers. An exemplary edge emitting laser may comprise a plurality of layers, for example, that form a stack. Like the surface emitting laser described above, the edge emitting laser comprises a core region surrounded by cladding. This core region may comprise semiconductor material that provides optical gain. The edge emitting laser may further comprise reflectors on opposite ends that form optical cavity, which includes this optical gain material therein. These reflectors may comprise reflective surfaces disposed at opposite edges of the stack. The reflectors may be cleaved surfaces or dielectric coatings. One of the reflectors may be partially reflecting such that light escapes the optical cavity and is output through the edge of the laser.

Other types of edge emitting lasers may also be used. For example, the reflectors may comprise Bragg reflectors. Alternatively, such reflectors may be excluded in a distributed feedback laser wherein a grating extends along the core region. Anti-reflective (AR) coatings may be disposed at the opposite ends of the resonator cavity. Still other configurations and designs are possible.

The auxiliary optics 801 includes a microlens array 834 that receives the light beam emitted from the edge emitting laser. The microlens array 834 may comprise a silicon microlens array. This microlens array 834 may be actively aligned on the substrate 832 in some embodiments. The auxiliary optics 801 further comprises a deflecting mirror 836 bonded to the substrate 832. This deflecting mirror 836 may include, for example, a Au coated mirror surface. Microlenses in the microlens array 834 and the deflecting mirror 836 may form a plurality of optical paths that are aligned with a plurality of output ports of the edge emitting lasers in the die.

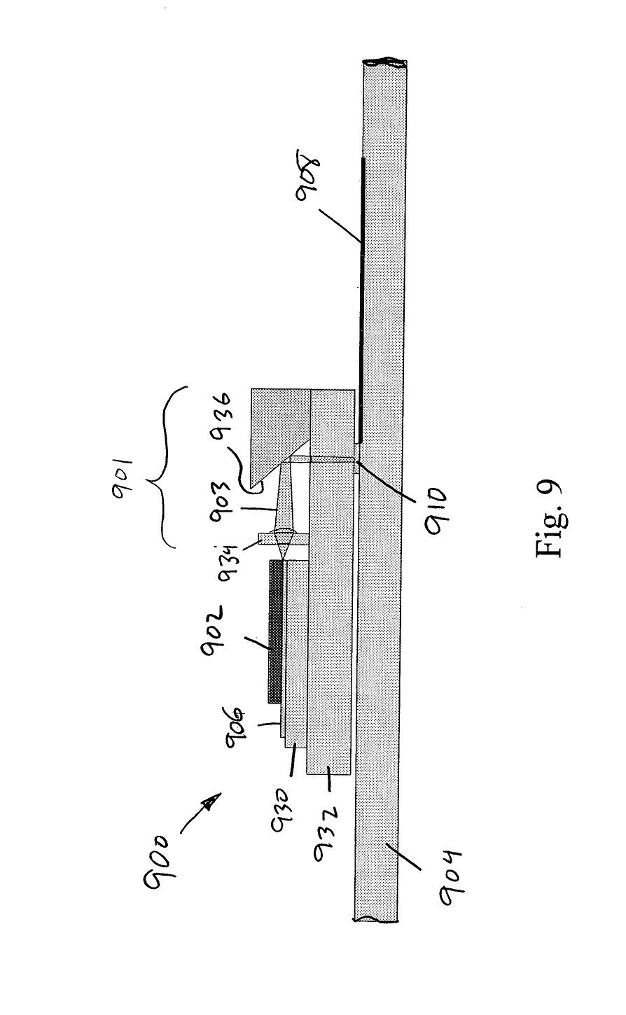

FIG. 9 shows such a laser module 900 bonded to a photonic integrated circuit chip 904. The laser module 900 similarly comprises a laser die 902 comprising a plurality of lasers, one of which is shown in the cross section of FIG. 9. The laser module further comprises auxiliary optics 901 for manipulating a laser beam 903 exiting one of the lasers in the laser die 902. FIG. 9 shows the laser die 902 bonded to contacts or contact pads 906 on a terrace 930 on a substrate 932. As described above, the substrate 932 may comprise AR coating(s). The auxiliary optics 901 includes a microlens array 934 and a deflecting mirror 936 bonded to the substrate 932.

The laser beam 903 exits an output port at the edge of the laser diode die 902. This laser beam 903 propagates through a lens in the lens array 934 and to the deflecting mirror 936 where the beam is deflected in a perpendicular direction through the silicon substrate 932 and to the photonic integrated circuit chip 904. As shown in FIG. 9, the laser beam 903 is incident on an optical coupler 910 in the photonic integrated circuit chip 904. The optical coupler 910 couples the light into a waveguide or waveguide structure 908 such as illustrated. In certain embodiments, the optics 901, for example, the lens array 934, provide mode size transformation and mode matching of the edge emitting laser with the optical coupler 910, which may comprise a waveguide grating coupler. The position, incident angle, shape, and size of the laser beam 903 may be controlled to provide increased matching and coupling. In certain embodiments, the beam 903 may have a beamwaist located about 40 microns below the module substrate 932. This beam waist may be about 3 to 10 microns in diameter. At least a portion of the upper surface of the module substrate 932 may be AR coated to reduce reflection at the air/substrate interface. Similarly, at least a portion of the lower surface of the module substrate 932 may be AR coated to reduce reflection. Epoxy may be used to bond the module 900 to the photonic chip 904. Accordingly, the lower surface of the module substrate 932 may be AR coated to reduce reflection at this substrate/epoxy interface. Other configurations and designs are also possible.

The module may provide advantages in manufacturing in some cases. Also, in certain embodiments, the module 900 may have a lid, and the laser diode 902 can be hermetically sealed.

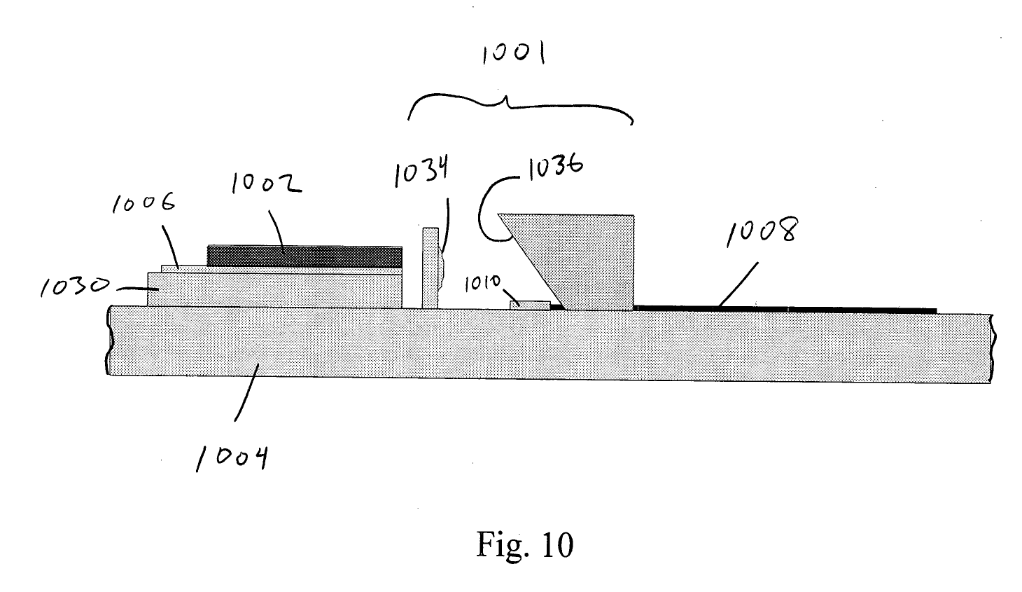

As illustrated in FIG. 10, a laser die 1002 comprising an edge emitting laser 1002 may be bonded to a photonic integrated circuit chip 1004 even without the use of a laser module 900. FIG. 10 shows the laser die 1002 bonded to contacts or contact pads 1006 on a terrace 1030 on the photonic chip 1004. This photonic chip 1004 may include an AR coating formed thereon. Auxiliary optics 1001 comprising a microlens 1034 and a deflecting mirror 1036 are bonded to the photonics chip 1004. This photonic chip 1004 includes an optical coupler 1010 (e.g., grating coupler) and a waveguide structure 1008. The discussion above with regard to the edge emitting lasers, laser beam propagation through an optical path defined by the lens 1034 and the deflecting mirror 1036 and mode matching apply to the configuration shown in FIG. 10. As described above, the lens 1034 as well as the deflecting mirror 1036 may provide for suitable size, shape, angle of incidence, and location of the beam for efficient coupling into the optical coupler 1010.

A variety of types of lens and mirrors may be used for the lens 1034 and deflecting mirror 1036 shown in FIGS. 8-10. For example, the lens 1034 and mirror 1036 may comprise different materials (e.g., other than silicon or silicon-based) and may have a wide variety of shapes including spherical, aspheric, cylindrical, or other shapes. In some embodiments, the deflecting mirror 1036 may have optical power. The lens 1034 may also comprise a diffractive optical element such as a diffractive or holographic lens, or a graded index lens. Additional optical elements may be added or may be removed. For example, the functions of the lens 1034 and mirror 1036 may be combined into one optical element in certain embodiments. The order of the optical elements may vary. Also as discussed above, more than one optical device, e.g., edge emitting laser diode, may be mounted on the photonics chip 1004. Still other configurations are possible.

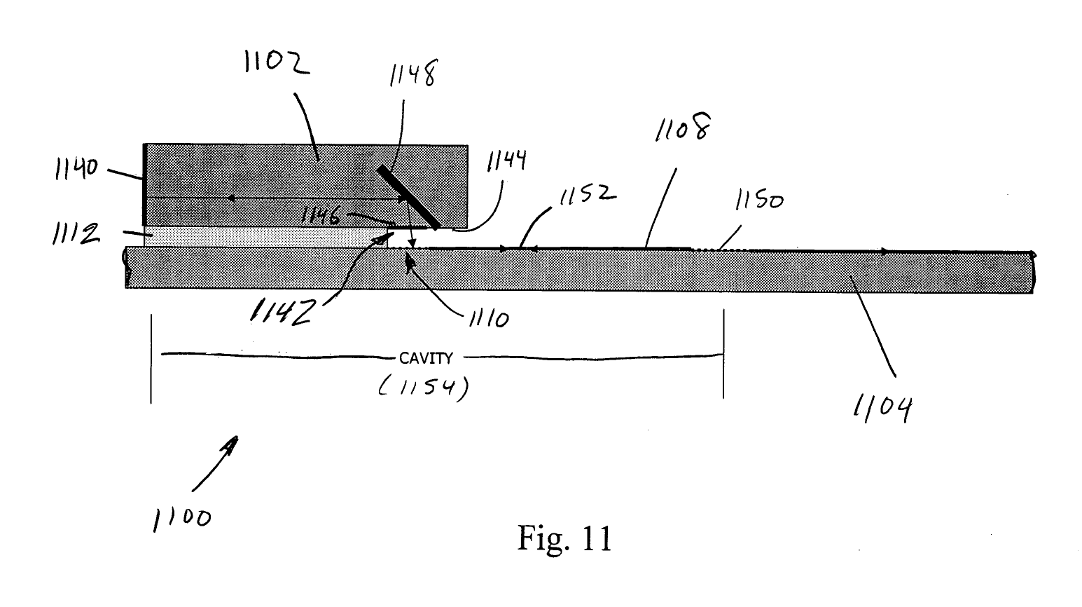

As described above, optical devices other than lasers may be bonded to photonic chips as well. FIG. 11, for example, shows of an amplifier device 1102 bonded to a photonic integrated circuit chip 1104 to form an external cavity laser 1100.

The amplifier device 1102 comprises an optical gain medium comprising, for example, semiconductor material such as III-V semiconductor material. The amplifier 1102 may comprise other types of material including other non-silicon based materials. The amplifier 1102 may be a guided structure comprising a core region, e.g. surrounded by cladding. In the embodiment shown in FIG. 11, a first reflector 1140 is disposed on one side of the amplifier device 1102. The amplifier 1102 includes an input/output port 1142 through which light can enter or exit the amplifier. In the embodiment shown in FIG. 11, this port 1142 is disposed on a surface 1144 of the amplifier 1102 facing the photonic integrated circuit chip 1104. An AR coating 1146 may be included on this surface 1144 to reduce Fresnel reflection at this port 1142. The amplifier 1104 further comprises a coupling structure 1148 that may comprise, for example, a mirror to couple the light out of the amplifier.

The photonic integrated circuit chip 1104 includes an optical coupler 1110 such as, e.g., a grating coupler and a waveguide 1108 coupled to the grating coupler. A second reflector 1150 comprising, for example, a Bragg grating, is disposed in the waveguide 1108. A phase controller 1152 is also inserted in the waveguide 1108.

The first and second reflectors 1140 and 1150 form an optical cavity 1154. The phase controller 1152 can be tuned to provide the appropriate resonance. An optical path extends through this optical cavity 1154 from the first reflector 1140, to the optical coupler 1148, through the port 1142 to the optical coupler 1110, and through the waveguide 1108 to the second reflector 1150. Portions of this optical cavity 1154 are therefore within both the amplifier device 1102 and the photonic integrated circuit chip 1104. Light may be amplified in the amplification device 1102 and resonate and be output as laser light through the second reflector 1150 in the waveguide 1108.

The amplifier 1102 is positioned such that the port 1142 in the amplifier is aligned with an optical coupler (e.g., a grating coupler) 1110 in the photonic integrated circuit chip. The coupling structure 1148 may be configured to substantially optically match the modes in the amplifier to the grating coupler 1110. In certain embodiments, the coupling structure 1148 comprises a mirror having a shape, position, and orientation to provide suitable shape, size, location, and angle of incidence for the beam directed onto the grating coupler 1110. In other embodiments, the coupling structure 1148 may comprise a grating. Other types of structures may be employed. Additional optical elements, such as lens, may also be included.

Similarly, the first and second reflectors 1140, 1150 may be different. For example, the first reflector 1140 may comprise a cleaved surface, a dielectric coating, or may be replaced by a Bragg grating. Still other designs are possible for the reflectors 1140, 1150 and the optical cavity 1154. In other embodiments, for example, the amplifier 1102 may be an edge emitting device such as shown in FIGS. 8-10 and may be included in an amplifier module such that the amplifier can be hermetically sealed. Electrical feedthroughs may provide electrical connection through the seal.

A solder bond 1112 joins the amplifier 1102 to the photonic integrated circuit chip 1104. Advantageously, the amplifier 1102 may be passively aligned and bonded to the photonic integrated circuit chip 1104. Fiducials may, for example, permit visual alignment. Alignment may be automated. Because the amplifier 1102 can be passively aligned, no optical signal need be output by the amplifier or input into the amplifier to accomplish such alignment. In other embodiments, such an optical signal is employed to actively align the amplifier 1102.

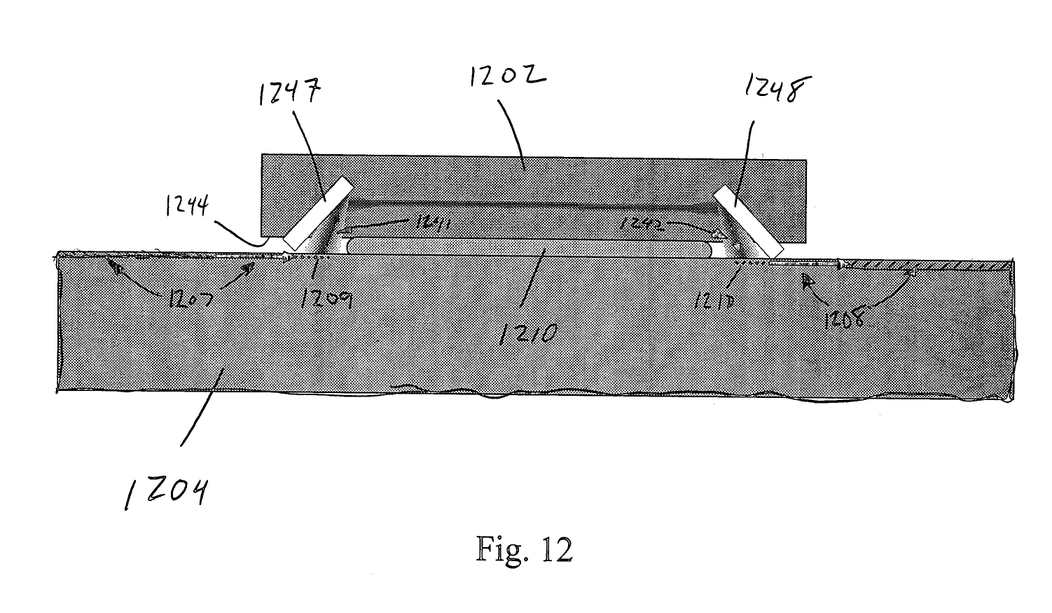

An amplifier device 1202 may be bonded to a photonic integrated circuit chip 1204 to amplify a signal propagating in the photonic chip as shown in FIG. 12.

The amplifier device 1202 comprises an optical gain medium comprising, for example, semiconductor material such as III-V semiconductor material. The amplifier 1202 may comprise other types of material including other non-silicon based materials. The amplifier 1202 may be a guided structure comprising a core region, e.g., surrounded by cladding. In the embodiment shown in FIG. 12, an input port 1241 is disposed on a first side of the amplifier device 1202 and an output port 1242 is disposed on a second side of the amplifier device. In the embodiment shown in FIG. 12, both ports 1241, 1242 are located on a surface 1244 of the amplifier 1202 facing the photonic integrated circuit chip 1204. AR coatings (not shown) may be included on this surface 1244 to reduce Fresnel reflection at these ports 1241, 1142. The amplifier 1202 further comprises first and second coupling structures 1247, 1248 disposed on the first and second sides proximal the entrance and exit ports 1241, 1242. The coupling structures 1247, 1248 may comprise, for example, mirrors to couple light into and out of the amplifier 1202.

The photonic integrated circuit chip 1204 includes a first and second optical couplers 1209, 1210 comprising, e.g., grating couplers, and first and second waveguide portions 1207, 1208 coupled to the first and second grating couplers, respectively.

An optical path extends from the first waveguide portion 1207 and the first grating coupler 1209 through the input port 1241 to the first coupling structure 1247, through the amplifier 1202 to the second coupling structure 1248, and through the exit port 1242 to the second grating coupler 1210 and the second waveguide portion 1208. Portions of this optical path are therefore within both the amplifier device 1202 and the photonic integrated circuit chip 1204. An optical signal propagating in the photonic integrated circuit chip 1204 may, thus, be directed into the amplifier 1202 where the optical signal is amplified.

The amplifier 1202 is positioned such that the entrance and exit ports 1241, 1242 in the amplifier are aligned with the optical couplers (e.g., a grating coupler) 1209, 1210 on the photonic integrated circuit chip 1204. The coupling structures 1247, 1248 may be configured to substantially optically match the modes in the amplifier 1202 to the grating couplers 1209, 1210. In certain embodiments, the coupling structures 1247, 1248 comprise mirrors or gratings. Other types of structures may be employed. Additional optical elements, such as lens, may also be included.

Still other designs are possible. In other embodiments, for example, the amplifier may be an edge emitting device such as shown in FIGS. 8-10 and may be included in an amplifier module such that the amplifier can be hermetically sealed. Electrical feedthroughs may provide electrical connection through the seal.

A solder bond 1210 joins the amplifier 1202 to the photonic integrated circuit chip 1204. Advantageously, the amplifier 1202 may be passively aligned and bonded to the photonic integrated circuit chip 1204. Fiducials may, for example, permit visual alignment. Alignment may be automated. Because the amplifier 1202 can be passively aligned, no optical signal need be output by the amplifier or input into the amplifier to accomplish such alignment. In other embodiments, such an optical signal is employed to actively align the amplifier 1202.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others.

What is claimed is:

1. An optical apparatus comprised of:
an array of optical grating couplers fabricated on a substrate and an array of optical devices,
where the array of optical grating couplers is optically aligned to the optical devices.

2. An optical apparatus of claim 1, wherein the array of optical grating couplers and the array of optical devices is secured by mechanical attachment.

3. An optical apparatus of claim 1, wherein the array of optical devices is comprised of one or more arrayed elements from the list including: VCSELs, lasers, detectors, surface emitting lasers, light emitting diodes, super luminescent diodes, modulators, filters, fibers, fiber components, lenses, diffractive lenses, grating couplers, optical amplifiers, mirrors, and resonant cavities.

4. An optical apparatus of claim 1, wherein the substrate is formed from one or more of the following material systems: a silicon substrate, a silicon on insulator substrate, an indium phosphide substrate, a gallium arsenide substrate, and/or a germanium substrate.

5. An optical apparatus of claim 2, wherein the securing mechanical attachment comprises a plurality of electrical connections between the array of optical devices and the substrate.

6. An optical apparatus of claim 5, wherein at least one of the plurality of electrical connections is comprised of solder commonly involved in commercial bump bonding operations.

7. An optical apparatus of claim 5, wherein at least one of the plurality of electrical connections is comprised of a gold bump commonly involved in commercial flip-chip operations.

8. An optical apparatus of claim 5, wherein the plurality of electrical connections is coupling a plurality of transistors formed on the substrate and the array of optical devices.

9. An optical apparatus of claim 8, wherein the plurality of transistors supply electrical signals to the array of optical devices.

10. An optical apparatus of claim 8, wherein the plurality of transistors is used to sense and process electrical signals from the array of optical devices.

11. An optical apparatus of claim 8, wherein the plurality of transistors is formed with a CMOS process.

12. An optical apparatus of claim 1, wherein the mode field of the array of optical grating couplers is designed to match the mode field of the array of optical devices.

13. An optical apparatus of claim 1, wherein the plurality of output signals of the array of optical grating couplers comprises a plurality of output signals of a wavelength demultiplexing device.

14. An optical apparatus of claim 2, wherein the mechanical attachment is formed by a wafer bonding process.

15. An optical apparatus of claim 2, wherein the mechanical attachment is formed by fabricating the array of optical devices on top of the substrate.

16. An optical apparatus comprised of:
a plurality of optical grating couplers fabricated on a substrate and a plurality of optical devices,
where the plurality of optical grating couplers is optically aligned to the plurality of optical devices.

17. An optical apparatus of claim 16, wherein the plurality of optical grating couplers and the plurality of optical devices is secured by mechanical attachment.

18. An optical apparatus of claim 16, wherein the plurality of optical devices is comprised of one or more arrayed elements from the list including: VCSELs, lasers, detectors, surface emitting lasers, light emitting diodes, super luminescent diodes, modulators, filters, lenses, diffractive lenses, grating couplers, optical amplifiers, mirrors, and resonant cavities.

19. An optical apparatus of claim 16, wherein the substrate is formed from one or more of the following material systems: a silicon substrate, a silicon on insulator substrate, an indium phosphide substrate, a gallium arsenide substrate, and a germanium substrate.

20. An optical apparatus of claim 17, wherein the securing mechanical attachment is comprised of a plurality of electrical connections between the plurality of optical devices and the substrate.

21. An optical apparatus of claim 20, wherein at least one of the plurality of electrical connections is comprised of C4 solder commonly involved in commercial bump bonding operations.

22. An optical apparatus of claim 20, wherein at least one of the plurality of electrical connections is comprised of a gold bump commonly involved in commercial flip-chip operations.

23. An optical apparatus of claim 20, wherein the plurality of electrical connections is coupling a plurality of transistors formed on the substrate and the plurality of optical devices.

24. An optical apparatus of claim 22, wherein the plurality of transistors supply electrical signals to the plurality of optical devices.

25. An optical apparatus of claim 22, wherein the plurality of transistors is used to sense and process electrical signals from the plurality of optical devices.

26. An optical apparatus of claim 22, wherein the plurality of transistors is formed with a CMOS process.

27. An optical apparatus of claim 16, wherein the mode field of the plurality of optical grating couplers is designed to substantially match the mode field of the plurality of optical devices.

28. An optical apparatus of claim 16, wherein the plurality of output signals of the plurality of optical grating couplers comprises a plurality of output signals of a wavelength demultiplexing device.

29. An optical apparatus of claim 17, wherein the mechanical attachment is formed by a wafer bonding process.

30. An optical apparatus of claim 17, wherein the mechanical attachment is formed by fabricating the plurality of optical devices on top of the substrate.

31. An optical apparatus comprised of:
an array of optical grating couplers formed on a first substrate,
an array of optical devices formed on a second substrate, where the first substrate is a silicon on insulator substrate and the second substrate is an indium-phosphide based substrate and where the substrates are mechanically fixed in optical alignment.

32. A method for attaching an array of optical devices to an array of optical grating couplers formed on a substrate, comprising the steps of:
placing a plurality of alignment marks on the substrate,
aligning the first of the array of optical devices to the first of the array of optical grating couplers,
aligning the last of the array of optical devices to the last of the array of optical grating couplers, and
attaching the array of optical devices to the array of optical grating couplers.

33. The method of claim 32, wherein each step of aligning further comprises the step of:
using a vision system with a pattern recognition for automated alignment.

34. The method of claim 32, wherein each step of aligning further comprises the step of:
using a plurality of mask alignment marks on a plurality of masks used to fabricate an array of optical devices for alignment.

35. The method of claim 32, wherein each step of aligning further comprises the step of:
sending a plurality of optical signals via a plurality of waveguides in the substrate to the array of optical grating couplers,
detecting a plurality of optical output signals from the array of optical grating couplers, and
aligning the array of optical devices to increase the magnitude of the plurality of the optical output signals from the array of optical grating couplers.

36. The method of claim 32, wherein each step of aligning further comprises the step of:
sending a plurality of electrical signals to an array of light sources, detecting a plurality of optical output signals from the array of light sources, using an array of optical grating couplers on the substrate, and
aligning the array of light sources to increase the magnitude of the plurality of the optical output signals from the array of light sources.

37. An optoelectronic circuit integrated on a substrate for converting a plurality of optical signals to a plurality of electrical signals, comprising:
a plurality of planar waveguides providing the plurality of optical signals at a plurality of output ports,
an array of optical grating couplers, with a plurality of input ports coupled to the output ports of the plurality of waveguides, and
an array of photodetectors, with each of the photodetectors coupled to a separate output of one of the array of optical grating couplers, and each photodetector generating an electrical output signal in response to the detected optical signal.

38. An optoelectronic circuit integrated on a substrate for converting a plurality of electrical signals to a plurality of optical signals, comprising:
a plurality of electrical signal lines providing a plurality of electrical signals,
an array of light sources, with each of the light sources coupled to a separate one of the plurality of electrical signal lines, and each light source generating an optical output signal in response to the received optical signal.

39. An optoelectronic circuit integrated on a substrate for electrical signal distribution, comprising:
a light source for generating an optical signal at an output port in response to a received electrical signal,
an optical grating coupler with an input port coupled to the output port of the light source, and with an output port,
a light splitting planar waveguide device, comprised of a waveguide and a light splitter, with an input port coupled to the output port of the optical grating coupler, and with a plurality of output ports,
an array of optical grating couplers, with each input port coupled to a separate one of the plurality of output ports of the light splitting planar waveguide device, and with a plurality of output ports, and
an array of photodetectors, with each photodetector coupled to a separate one of the outputs of the array of optical grating couplers, and where each photodetector generates an electrical signal in response to the detected optical signal.

40. An optical apparatus comprising:
at least one optical device;
a photonic integrated circuit chip, said at least one optical device flip-chip bonded to said photonic integrated circuit chip; and
a substantially flux-free bond providing electrical connection to said optical device and said photonic integrated circuit chip.

41. The optical apparatus of claim 40, wherein said at least one optical device comprises a surface emitting laser, an edge emitting laser, a light emitting diode, a super luminescent diode, an optical amplifier, or a detector.

42. The optical apparatus of claim 40, wherein said photonic integrated circuit chip comprises silicon.

43. The optical apparatus of claim 42, wherein said photonic integrated circuit chip comprises a silicon substrate.

44. The optical apparatus of claim 42, wherein said photonic integrated circuit chip comprises a silicon-on-insulator substrate.

45. The optical apparatus of claim 40 wherein said substantially flux free bond comprises a flux-free eutectic bond.

46. The optical apparatus of claim 40, wherein said substantially flux-free bond comprises a AuSn bond or a Au bond.

47. The optical apparatus of claim 40, wherein said AuSn bond is between about 3 to 5 micrometers thick.

48. A method of manufacturing an optical apparatus comprising:
flip-chip bonding at least one optical device to a photonic integrated circuit chip using substantially flux-free solder to provide electrical connection between said optical device and said photonic integrated circuit chip.

49. The method of claim 48, wherein said at least one optical device comprises a surface emitting laser, an edge emitting laser, a light emitting diode, a super luminescent diode, an optical amplifier, or a detector.

50. The method of claim 48, wherein said photonic integrated circuit chip comprises silicon.

51. The method of claim 48, wherein a bond is formed with AuSn solder or Au solder.

52. An optical apparatus comprising:
at least one optical device;
a photonic integrated circuit chip, said at least one optical device bonded to said photonic integrated circuit; and
means for forming a fluxless electrical bond between said optical device and said photonic integrated circuit chip.

53. The optical apparatus of claim 52, wherein said at least one optical device comprises a surface emitting laser, an edge emitting laser, a light emitting diode, a super luminescent diode, an optical amplifier, or a detector.

54. The optical apparatus of claim 52, wherein said photonic integrated circuit chip comprises a silicon-based waveguide structures.

55. The optical apparatus of claim 52, wherein said fluxless electrical bonding means comprises a AuSn eutectic bond.

56. An optical apparatus comprising:
at least one optical device;
a photonic integrated circuit chip, said at least one optical device flip-chip bonded to said photonic integrated circuit, said photonic integrated circuit chip comprising a least one optical coupler configured to couple light between said at least one optical device and said photonic integrated circuit chip; and
substantially optically transmissive filler material in an optical path between said at least one optical device and said optical coupler.

57. The optical apparatus of claim 56, wherein said at least one optical device comprises a surface emitting laser, an edge emitting laser, a light emitting diode, a super luminescent diode, an optical amplifier, or a detector.

58. The optical apparatus of claim 56, wherein said photonic integrated circuit chip comprises silicon.

59. The optical apparatus of claim 58, wherein said photonic integrated circuit chip comprises a silicon substrate.

60. The optical apparatus of claim 58, wherein said photonic integrated circuit chip comprises a silicon-on-insulator substrate.

61. The optical apparatus of claim 56, wherein said optical coupler comprises a grating coupler.

62. The optical apparatus of claim 56, wherein said substantially optically transmissive material comprises organic material.

63. The optical apparatus of claim 62, wherein said substantially optically transmissive material comprises epoxy or silicone.

64. The optical apparatus of claim 56, wherein said filler material extends from said at least one optical device to said optical coupler.

65. The optical apparatus of claim 56, further comprising an optical element disposed in said optical path, said filler material extending from said optical element to said optical coupler.

66. The optical apparatus of claim 65, wherein said optical element comprises a lens.

67. A method of manufacturing an optical apparatus comprising:
flip-chip bonding at least one optical device to a photonic IC chip, said at least one optical device having an optical port and said photonic IC chip having an optical coupler, an optical path defined by said optical port and said optical coupler when said at least one optical device is flip-chip bonded to said photonic IC chip; and
providing substantially optical transmissive filler material in said optical path between said optical port and said optical coupler.

68. The method of claim 67, wherein said at least one optical device comprises a surface emitting laser, an edge emitting laser, a light emitting diode, a super luminescent diode, an optical amplifier, or a detector.

69. The method of claim 67, wherein said photonic IC chip comprises silicon.

70. The method of claim 67, wherein said filler material comprise dielectric.

71. The method of claim 67, wherein said filler material comprise organic material.

72. The method of claim 67, further comprising reducing Fresnel reflection between said optical port and said optical coupler with said filler material.

73. The method of claim 67, further comprising protecting said optical coupler with said filler material.

74. The method of claim 67, further comprising protecting a lens in said optical path with said filler material.

75. An optical apparatus comprising:
at least one optical device;
a photonic integrated circuit chip, said at least one optical device bonded to said photonic integrated circuit chip; and
means for providing mechanical support in said optical path between said optical device and said photonic integrated circuit chip.

76. The optical apparatus of claim 75, wherein said at least one optical device comprises a surface emitting laser, an edge emitting laser, a light emitting diode, a super luminescent diode, an optical amplifier, or a detector.

77. The optical apparatus of claim 75, wherein said photonic integrated circuit chip comprises a silicon-based waveguide structure.

78. The optical apparatus of claim 75, wherein said mechanical support means comprises substantially optically transmissive material.

79. An optical apparatus comprising:
at least one surface emitting laser comprising gain medium disposed in an optical resonant cavity having an optical axis, said surface emitting laser further comprising an output coupling element such that light exits said resonant cavity at an oblique angle with respect to said optical axis; and
a photonic IC chip comprising an optical coupler, said at least one edge emitting laser flip-chip bonded to said photonic IC chip so as to form an optical path from said output coupling element of said surface emitting laser to said optical coupler of said photonic IC chip.

80. The optical apparatus of claim 79, wherein said surface emitting laser comprises a plurality of layers disposed on a substrate that form a core region and surrounding cladding, at least said core region comprising semiconductor material.

81. The optical apparatus of claim 79, wherein said surface emitting laser comprises first and second reflectors that form said optical cavity, said first and second reflectors orient substantially transverse to said layers.

82. The optical apparatus of claim 81, wherein at least one of said first and second reflectors comprises a cleaved surface or a dielectric coating.

83. The optical apparatus of claim 81, wherein at least one of said first and second reflectors comprises a Bragg grating.

84. The optical apparatus of claim 79, wherein said surface emitting laser comprises a distributed feedback laser comprising a grating structure disposed along said optical axis in said optical cavity.

85. The optical apparatus of claim 79, wherein said output coupling element comprises a grating or a mirror.

86. The optical apparatus of claim 79, wherein said surface emitting laser comprises III-V semiconductor material.

87. The optical apparatus of claim 79, wherein said photonic IC chip comprises silicon.

88. The optical apparatus of claim 87, wherein said photonic IC chip comprises a silicon substrate.

89. The optical apparatus of claim 87, wherein said photonic IC chip comprises a silicon-on-insulator substrate.

90. The optical apparatus of claim 79, wherein said optical coupler comprises a grating coupler.

91. The optical apparatus of claim 79, further comprising a lens in said optical path between said output coupling element of surface emitting laser and said optical coupler of said photonic IC chip.

92. A method of manufacturing an optical apparatus comprising:
flip-chip bonding at least one surface emitting laser comprising a resonant cavity having an optical axis passing therethrough to a photonic IC chip comprising an optical coupler, said surface emitting laser further comprising an output coupling element such that light exits said resonant cavity at an angle with respect to said optical axis; and
aligning said at least one edge emitting laser with respect to said photonic IC chip such that light exiting through said output coupling element of said surface emitting laser propagates to said optical coupler of said photonic IC chip.

93. The method of claim 92, wherein said surface emitting laser comprises III-V semiconductor material.

94. The method of claim 92, wherein said photonic IC chip comprises silicon.

95. The method of claim 92, further comprising disposing a lens between said optical coupling element of said surface emitting laser and said optical coupler of said photonic IC chip.

96. An optical apparatus comprising:
means for emitting laser light;
a photonic integrated circuit chip comprising an optical coupler; and
means for bonding said means for emitting laser light to said photonic integrated circuit chip; and
means for outputting said light from said means for emitting laser light to said optical coupler of said photonic integrated circuit chip.

97. The optical apparatus of claim 96, wherein said means for emitting laser light comprises a surface emitting laser.

98. The optical apparatus of claim 96, wherein said photonic integrated circuit chip comprises silicon.

99. The optical apparatus of claim 96, wherein said bonding means comprises a solder bond.

100. The optical apparatus of claim 96, wherein said outputting means comprises a mirror or grating.

101. The optical apparatus of claim 96, wherein said optical coupler of said photonic integrated circuit chip comprises a grating coupler.

102. An optical apparatus comprising:
at least one edge emitting laser comprising gain medium disposed between first and second ends of an optical resonant cavity, light in said resonant cavity can exiting through said second end;
a photonic IC chip comprising an optical coupler, said at least one edge emitting laser bonded to said photonic IC chip; and
a beam deflector disposed so as to direct light exiting through said second reflector of said edge emitting laser to said optical coupler.

103. The optical apparatus of claim 102, wherein said edge emitting laser comprises a plurality of layers disposed on a substrate, said plurality of layers forming a core region surrounded by cladding, at least said core region comprising semiconductor material.

104. The optical apparatus of claim 102, wherein said first and second reflectors are oriented substantially transverse to said layers.

105. The optical apparatus of claim 102, wherein at least one of said first and second reflectors comprises a cleaved surface, a dielectric coating, or a Bragg grating.

106. The optical apparatus of claim 102, wherein said edge emitting laser comprises a distributed feedback laser comprising a grating structure along an optical axis through said optical cavity.

107. The optical apparatus of claim 102, wherein said edge emitting laser comprises III-V semiconductor material.

108. The optical apparatus of claim 102, wherein said photonic IC chip comprises silicon.

109. The optical apparatus of claim 108, wherein said photonic IC chip comprises a silicon substrate.

110. The optical apparatus of claim 108, wherein said photonic IC chip comprises a silicon-on-insulator substrate.

111. The optical apparatus of claim 108, wherein said optical coupler comprises a grating coupler.

112. The optical apparatus of claim 102, wherein said beam deflector comprises a tilted mirror.

113. The optical apparatus of claim 102, further comprising a lens in an optical path between said edge emitting laser and said optical coupler.

114. A method of manufacturing an optical apparatus comprising:
flip-chip bonding at least one edge emitting laser to a photonic IC chip comprising an optical coupler; and
disposing a beam deflector at a position to direct light from said edge emitting laser to said optical coupler.

115. The method of claim 114, wherein said edge emitting laser comprises III-V semiconductor material.

116. The method of claim 114, wherein said photonic IC chip comprises silicon.

117. The method of claim 116, further comprising disposing a lens between said edge emitting laser and said beam deflector.

118. An optical apparatus comprising:
means for emitting laser light;
a photonic integrated circuit chip comprising an optical coupler; and
means for bonding said means for emitting laser light to said photonic integrated circuit chip; and
means for deflecting said light from said means for emitting laser light to said optical coupler of said photonic integrated circuit chip.

119. The optical apparatus of claim 118, wherein said means for emitting laser light comprises an edge emitting laser.

120. The optical apparatus of claim 118, wherein said photonic integrated circuit chip comprises silicon.

121. The optical apparatus of claim 118, wherein said bonding means comprises a solder bond.

122. The optical apparatus of claim 118, wherein said deflecting means comprises an angled mirror surface.

123. An optical apparatus comprising:
at least one optical device comprising a gain medium and a first reflector; and
a photonic integrated circuit chip, said at least one optical device bonded to said photonic integrated circuit chip, said photonic integrated circuit chip comprising a second reflector, said first reflector and said second reflector forming an optical cavity with said gain medium disposed in said optical cavity.

124. The optical apparatus of claim 123, wherein said first reflector comprises an optical coating.

125. The optical apparatus of claim 123, wherein said photonic integrated circuit chip comprises silicon.

126. The optical apparatus of claim 125, wherein said photonic integrated circuit chip comprises a silicon substrate.

127. The optical apparatus of claim 125, wherein said photonic integrated circuit chip comprises a silicon-on-insulator substrate.

128. The optical apparatus of claim 123, wherein said second reflector comprises a grating-reflector.

129. The optical apparatus of claim 123, wherein said photonic integrated circuit chip comprises an optical coupler disposed in said optical cavity.

130. The optical apparatus of claim 129, wherein optical coupler comprises a grating coupler.

131. The optical apparatus of claim 123, wherein said photonic integrated circuit chip comprises a phase controller in said optical cavity.

132. A method of manufacturing an optical apparatus comprising:
flip-chip bonding at least one optical device comprising a gain medium and a first reflector to a photonic IC chip including a second reflector such that said first and second reflectors form an optical cavity and said gain medium is disposed in said optical cavity.

133. The method of claim 132, further comprising aligning said optical device with respect to said photonic integrated circuit chip such that an optical port of said optical device is aligned with an optical coupler of said photonic integrated circuit chip.

134. The method of claim 132, wherein said photonic IC chip comprises silicon.

135. The method of claim 134, wherein said photonic IC chip comprises a silicon substrate.

136. The method of claim 134, wherein said photonic IC chip comprises a silicon-on-insulator substrate.

137. An optical apparatus comprising:
means for providing gain comprising a gain medium and a first means for reflecting light;
a photonic integrated circuit chip comprising second means for reflecting light; and
means for bonding said gain means to said photonic integrated circuit chip such that said first and second reflecting means form an optical cavity with said gain medium disposed therein.

138. The optical apparatus of claim 137, wherein said gain means comprises a plurality of layers on a substrate.

139. The optical apparatus of claim 138, wherein said plurality of layers comprise cladding layers on opposite sides of a core region having gain.

140. The optical apparatus of claim 137, wherein said first reflecting means comprises a reflective coating.

141. The optical apparatus of claim 137, wherein said photonic integrated circuit chip comprises silicon.

142. The optical apparatus of claim 137, wherein flip-chip bonding means comprising a solder bond.

143. An optical apparatus comprising:
at least one amplifier device comprising gain medium, said at least one optical device having an input port and an output port; and
a photonic IC chip comprising an input port and an output port,
wherein said at least one amplifier device is bonded to said photonic IC chip such that said output port of said photonic IC chip is aligned along an optical path with said input port of said amplifier device and said output port of said amplifier device is aligned along an optical path with said input port of said photonic IC chip.

144. The optical apparatus of claim 143, wherein said gain medium comprises semiconductor material.

145. The optical apparatus of claim 144, wherein said semiconductor material comprises III-V semiconductor material.

146. The optical apparatus of claim 143, wherein said amplifier device further comprises reflective surfaces proximal said input and output ports.

147. The optical apparatus of claim 143, wherein said photonic IC chip comprises silicon.

148. The optical apparatus of claim 147, wherein said photonic IC chip comprises a silicon substrate.

149. The optical apparatus of claim 147, wherein said photonic IC chip comprises a silicon-on-insulator substrate.

150. The optical apparatus of claim 143, wherein said photonic IC chip comprises first and second optical couplers at said input and output ports, respectively.

151. The optical apparatus of claim 150, wherein said first and second optical couplers comprise grating couplers.

152. A method of manufacturing an optical apparatus comprising:
flip-chip bonding at least one amplifier device comprising a gain medium and having input and output ports to a photonic IC chip having input and output ports; and
positioning said amplifier device with respect to said photonic IC chip such that said output port of said photonic IC chip is substantially aligned with said input port of said amplifier device and said output port of said amplifier device is substantially aligned with said input port of said photonic IC chip.

153. The method of claim 152, wherein said gain medium comprises III-V semiconductor material.

154. The method of claim 152, wherein said photonic IC chip comprises silicon.

155. The method of claim 154, wherein said photonic IC chip comprises a silicon substrate.

156. The method of claim 154, wherein said photonic IC chip comprises a silicon-on-insulator substrate.

157. An optical apparatus comprising:
means for providing gain, said gain means having input and output ports;
a photonic IC chip having input and output ports; and
means for bonding said gain means to said photonic integrated circuit chip such that said output port of said photonic IC chip is substantially aligned with said input port of said amplifier device and said output port of said amplifier device is substantially aligned with said input port of said photonic integrated circuit chip.

158. The optical apparatus of claim 157, wherein said gain means comprises an amplifier chip.

159. The optical apparatus of claim 158, wherein said amplifier chip comprises III-V material.

160. The optical apparatus of claim 157, wherein said photonic integrated circuit chip comprises silicon.

161. The optical apparatus of claim 157, wherein said bonding means comprises a solder bond.
